(19) United States
(12) Patent Application Publication
(10) Pub. No.: US 2021/0339754 A1
(43) Pub. Date: Nov. 4, 2021

(54) DATA ANALYSIS METHOD AND APPARATUS, ELECTRONIC DEVICE AND COMPUTER STORAGE MEDIUM

(71) Applicant: Shanghai SenseTime Lingang Intelligent Technology Co., Ltd., Shanghai (CN)

(72) Inventors: Sheng ZHANG, Shanghai (CN); Mingxing PENG, Shanghai (CN)

(21) Appl. No.: 17/377,626

(22) Filed: Jul. 16, 2021

Related U.S. Application Data
(63) Continuation of application No. PCT/CN2020/092589, filed on May 27, 2020.

(30) Foreign Application Priority Data
Sep. 30, 2019 (CN) 201910945674.1

(51) Int. Cl. B60W 40/08; G06K 9/00; G06K 9/62; G08G 1/16; B60W 50/14; B60W 30/095

(52) U.S. Cl. CPC B60W 40/08; G06K 9/00268; G06K 9/00845; G06K 9/6202; B60W 2540/221; B60W 50/14; B60W 30/0953; B60W 2540/30; G08G 1/16

(57) ABSTRACT

Disclosed in embodiments of the present disclosures are a data analysis method and apparatus, an electronic device, and a computer storage medium. The data analysis method comprises: receiving driver data sent by a DMS and vehicle data sent by an ADAS, the driver data comprising driver behavior data and a first device identifier of the DMS, and the vehicle data comprising vehicle driving data and a second device identifier of the ADAS; according to a first mapping between device identifiers and vehicle identifiers that is established in a database, determining vehicle identifiers respectively corresponding to the first device identifier and the second device identifier; and in response to the first device identifier and the second device identifier corresponding to the same vehicle identifier, analyzing the driver data and/or analyzing the vehicle data according to the driver behavior data and the vehicle driving data.

### CROSS-REFERENCE TO RELATED APPLICATIONS

This is a continuation of International Application No. PCT/CN2020/092589, filed on May 27, 2020, which is based on and claims priority to Chinese Patent Application No. 201910945674.1, filed on Sep. 30, 2019. The contents of International Application No. PCT/CN2020/092589 and Chinese Patent Application No. 201910945674.1 are incorporated herein by reference in their entireties.

### TECHNICAL FIELD

The present disclosure relates to data analysis techniques for vehicle systems, and more particularly, to a method and apparatus for data analysis, an electronic device, and a computer storage medium.

### BACKGROUND

For either a motorcade operated inside an enterprise, or a public oriented motorcade for a general passenger transport service or a logistics transport service, etc., how to manage the motorcade has always been a difficult problem encountered by enterprise operators. In the motorcade management, driver management and vehicle management are also important tasks, and therefore, an effective data analysis solution is needed.

### SUMMARY

An embodiment of the present disclosure provides a method for data analysis. The method includes: receiving driver data sent by a driver monitor system (DMS) and vehicle data sent by an advanced driving assistant system (ADAS), wherein the driver data includes driver behavior data and a first device identifier of the DMS, the vehicle data includes vehicle travel data and a second device identifier of ADAS, and the DMS and ADAS are provided in a vehicle; determining a vehicle identifier corresponding to the first device identifier and a vehicle identifier corresponding to the second device identifier according to a first mapping relationship between device identifiers and vehicle identifiers established in a database; and in response to the first device identifier and the second device identifier corresponding to a same vehicle identifier, performing at least one of driver data analysis or vehicle data analysis according to the driver behavior data and the vehicle travel data.

An embodiment of the present disclosure further provides an apparatus for data analysis. The device includes a receiving module, a first processing module, and a second processing module. The receiving module is configured to receive driver data sent by a driver monitor system (DMS) and vehicle data sent by an advanced driving assistant system (ADAS), wherein the driver data includes driver behavior data and a first device identifier of the DMS, the vehicle data includes vehicle travel data and a second device identifier of ADAS, and the DMS and ADAS are provided in a vehicle; the first processing module is configured to determine a vehicle identifier corresponding to the first device identifier and a vehicle identifier corresponding to the second device identifier according to a first mapping relationship between device identifiers and vehicle identifiers established in a database; and the second processing module is configured to at least one of driver data analysis or vehicle data analysis according to the driver behavior data and the vehicle travel data in response to the first device identifier and the second device identifier corresponding to a same vehicle identifier.

An embodiment of the present disclosure further provides an electronic device. The electronic device includes a processor and a memory configured to store a computer program executable by the processor. The processor is configured to execute the computer program to perform any of the above-described methods for data analysis.

An embodiment of the present disclosure further provides a computer storage medium having stored thereon a computer program which, when executed by a processor, implements any of the above-described methods for data analysis.

An embodiment of the present disclosure further provides a computer program product. The computer program product includes computer program instructions which cause a computer to implement any of the above-described methods for data analysis when executed.

It is to be understood that both the foregoing general description and the following detailed description are exemplary and explanatory only and are not to limit the disclosure.

### BRIEF DESCRIPTION OF THE DRAWINGS

The accompanying drawings, which are incorporated in and constitute a part of the specification, illustrate embodiments consistent with the present disclosure and, together with the description, serve to illustrate the technical solution of the disclosure.

FIG. 1 is a flow chart of a method for data analysis according to an embodiment of the present disclosure;

FIG. 2 is an architecture diagram of an application scenario according to an embodiment of the present disclosure;

FIG. 3 is a structural diagram of an apparatus for data analysis according to an embodiment of the present disclosure; and

FIG. 4 is a structural diagram of an electronic device according to an embodiment of the present disclosure.

### DETAILED DESCRIPTION

The embodiments of the present disclosure are described in further detail below with reference to the accompanying drawings and examples. It is to be understood that the embodiments provided herein are merely illustrative of the embodiments of the disclosure and are not intended to limit the embodiments of the disclosure. In addition, the following examples are provided for implementing some embodiments of the present disclosure, rather than providing all embodiments for carrying out the present disclosure. The technical solutions described in the embodiments of the present disclosure may be implemented in any combination without conflict.

It is to be noted that in the embodiments of the present disclosure, the terms “comprises,” “comprising,” or any other variation thereof, are intended to encompass a non-exclusive inclusion, such that a method or a device comprising a list of elements includes not only the elements expressly recited, but also other elements not expressly listed, or elements inherent to the method or device. Without more limitations, an element defined by the statement “comprises a . . . ” does not rule out additional relevant elements in the method or device comprising the element (e.g., a step in the method, or a unit in the device which may be part of a circuit, part of a processor, or part of a program or software).

For example, the methods for data analysis provided in the embodiments of the present disclosure include a series of steps. However, the methods for data analysis provided in the embodiments of the present disclosure are not limited to the steps described. Similarly, the devices for data analysis provided in the embodiments of the present disclosure include a series of modules. However, the devices provided in the embodiments of the present disclosure are not limited to the modules specifically described, and may further include the modules required for obtaining related information or for processing based on the information.

The term “and/or,” as used herein, is merely an association that describes an associated object, meaning that there may be three relationships. For example, A and/or B may mean that A alone, both A and B, and B alone, are present. Additionally, the term “at least one” as used herein denotes any combination of: any one of multiple objects, or at least two of multiple objects. For example, the inclusion of at least one of A, B, C may denote the inclusion of any one or more elements selected from the set consisting of A, B, and C.

The embodiments of the present disclosure may be applied in an application scenario of a computer system consisting of a vehicle-mounted device and a cloud platform, and may operate together with numerous other general-purpose or special-purpose computing system environments or configurations. Exemplarily, a vehicle-mounted device may be a DMS, ADAS, or other devices mounted on a vehicle, and a cloud platform may be a distributed cloud computation environment including a minicomputer system or a large computer system, or the like.

Vehicle-mounted devices, cloud platforms, or the like may be described in the general context of computer system executable instructions (such as program modules) executed by a computer system. Generally, program modules may include routines, programs, target programs, components, logic, data structures, etc., which perform particular tasks or implement particular abstract data types. In a cloud platform, tasks are performed by remote processing devices linked through a communication network. In a cloud platform, program modules may be located in a local or remote computing system storage medium including a storage device.

In the embodiment, the vehicle-mounted device may have a communication connection with a sensor, a positioning device, or the like, of the vehicle, and the vehicle-mounted device may acquire data collected by the sensor of the vehicle, geographical position information reported by the positioning device, or the like, through the communication connection. Exemplarily, the sensor of the vehicle may be at least one of a millimeter wave radar, a laser radar, a camera, or the like. The positioning device may be a device for providing a positioning service based on at least one of a Global Positioning System (GPS), a Beidou satellite navigation system, or a Galileo satellite navigation system.

In some embodiments of the present disclosure, a method for data analysis is provided, and the embodiments of the present disclosure may be applied to the fields of driving behavior analysis, vehicle operation management, driver management, business behavior analysis, or the like.

The method for data analysis of the embodiment of the disclosure may be applied to a cloud platform, which forms a communication connection with a vehicle-mounted device.

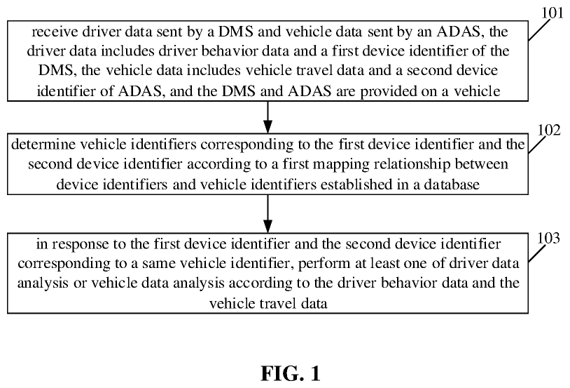

FIG. 1 is a flow chart of a method for data analysis according to an embodiment of the present disclosure. As shown in FIG. 1, the method may include steps 101 to 103.

In 101, driver data sent by a DMS and vehicle data sent by an ADAS is received, the driver data includes driver behavior data and a first device identifier of the DMS, the vehicle data includes vehicle travel data and a second device identifier of ADAS, and the DMS and ADAS are provided in a vehicle.

In this embodiment, the first device identifier is an identifier that uniquely indicates the DMS. The second device identifier is an identifier that uniquely represents the ADAS. The first device identifier of the DMS may be the ID of the DMS or other identifier information of the DMS, and the second device identifier of ADAS may be the ID of the ADAS or other identifier information of the ADAS.

Exemplarily, the driver behavior data may include at least one of yawning, making a call, drinking water, smoking, making up, a driver not in a driving position, or the like. The vehicle travel data may include at least one of a lane departure warning, a forward collision warning, an overspeed warning, a pedestrian in front of the vehicle, a backward collision warning, or an obstacle in front of the vehicle. It is to be understood that both the driver behavior data and the vehicle travel data may be alarm data. It should be noted that the foregoing is merely an exemplary description of the driver behavior data and the vehicle travel data, and in the embodiment of the disclosure, the driver behavior data and the vehicle travel data are not limited thereto.

The DMS mainly implements the functions of identifying a driver, monitoring driver fatigue and monitoring dangerous driving behavior. Exemplarily, a DMS may include a vehicle-mounted camera with an image acquisition direction of the vehicle-mounted camera facing the cabin. The DMS may analyze the driver image captured by the vehicle-mounted camera, and may generate the driver behavior data when it is determined from the analysis result that the driver behavior is a behavior requiring an alarm. The driver behavior data indicates a behavior requiring an alarm, for example, a fatigue driving behavior such as yawning, or a distracted driving behavior such as calling, drinking water, smoking, or making up. The ADAS may use various sensors (millimeter wave radar, laser radar, monocular/binocular camera, and satellite navigation) mounted on the vehicle to sense the surrounding environment, collect data, and identify, detect, and track the static or dynamic objects at any time during the driving of the vehicle. The ADAS may include a camera mounted on the vehicle, but the image acquisition direction is toward the outside of the vehicle. The ADAS may perform an analysis according to the image of the surrounding environment acquired by the camera, and when it is determined from the analysis result that the vehicle travel behavior is an behavior requiring an alarm, the vehicle travel data may be generated. The vehicle travel data indicates the vehicle travel behavior requiring an alarm. For example, the vehicle travel data may be a lane departure, a forward collision, an overspeed, a pedestrian in front of the vehicle, or the like.

Exemplarily, the DMS may report the driver data to the cloud platform after acquiring the driver data, or send the driver data to the cloud platform through the communication module on the vehicle. After obtaining the vehicle data, the ADAS may report the vehicle data to the cloud platform, or send the vehicle data to the cloud platform through the communication module on the vehicle.

In 102, a vehicle identifier corresponding to the first device identifier and a vehicle identifier corresponding to the second device identifier are determined according to a first mapping relationship between device identifiers and vehicle identifiers established in a database.

In the embodiment of the present disclosure, the vehicle identifier may be a license plate number or other identifier information of the vehicle. When the DMS sends the driver data to the cloud platform, the DMS may send the vehicle identifier to the cloud platform together. The ADAS may send the vehicle identifier to the cloud platform together when sending the vehicle data to the cloud platform.

In practical applications, after receiving the data sent by the DMS and ADAS, the cloud platform may establish the first mapping relationship between the device identifier and the vehicle identifier in the database according to the vehicle identifier carried in the data sent by the DMS and the vehicle identifier carried in the data sent by the ADAS. Exemplarily, the first mapping relationship includes a correspondence between the first device identifier and the vehicle identifier, and a correspondence between the second device identifier and the vehicle identifier. After establishing the first mapping relationship in the database, when the first device identifier and the second device identifier are received, the corresponding vehicle identifier may be found in the database according to the first mapping relationship respectively.

In 103, in response to the first device identifier and the second device identifier corresponding to a same vehicle identifier, at least one of driver data analysis or vehicle data analysis is performed according to the driver behavior data and the vehicle travel data.

In the present embodiment, when the first device identifier and the second device identifier correspond to the same vehicle identifier, the received driver behavior data and vehicle travel data correspond to the same vehicle. That is, the driver behavior data and the vehicle travel data of the same vehicle may be data-fused.

Exemplarily, the driver data analysis may be an analysis of the safety of the driving behavior of the driver, and the vehicle data analysis may be an analysis of the safety of the vehicle travel. It should be noted that the above-mentioned contents are merely illustrative of the driver data analysis and the vehicle data analysis, and the contents of the driver data analysis and the vehicle data analysis are not limited thereto in the embodiment of the disclosure.

In practical applications, steps 101 to 103 may be implemented based on a processor or the like of a cloud platform, which may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, or a microprocessor.

In the related art, the DMS or ADAS based on computer vision analysis is widely used, and at least one of the driver behavior or driving environment may be identified by the result of the computer vision analysis, and the driver behavior alarm function and driver behavior recording function may be provided. However, when the isolated data analysis is performed only for the data acquired by the DMS or ADAS, the results of the data analysis are not comprehensive and accurate. In some cases, the DMS and ADAS have no data exchange in the vehicle, or the DMS and ADAS are provided by two different companies, respectively. In the application scenario in which the multi-vehicle management is performed, the information reported by the DMS and ADAS to the cloud platform respectively may be isolated and unrelated.

However, in the embodiment of the disclosure, through adding a vehicle identifier to the data reported by the DMS and ADAS to the cloud platform, the data of the DMS and ADAS of the same vehicle may be correlated by establishing a correspondence relationship between the vehicle identifier and the device identifier. That is, the data reported by the DMS and ADAS of the same vehicle to the cloud platform may be correlated, and then the driver behavior data and the vehicle travel data of the same vehicle may be subjected to joint data analysis, thereby improving the comprehensiveness, accuracy and flexibility of the data analysis, and further achieving at least one of effective driver management, vehicle management, and/or motorcade management.

For example, when the analysis of the safety of the driving behavior of the driver is performed only according to the driver behavior data and the surrounding environment information of the vehicle is ignored, the safety evaluation result of the driving behavior of the driver may be inaccurate for the reason that the safety of the driving behavior of the driver is closely related to the surrounding environment information of the vehicle. However, in this embodiment of the present disclosure, the association relationship between the driver behavior data and the vehicle travel data of the same vehicle may be established by using the vehicle identifier, the first device identifier, and the second device identifier. Further, the driver behavior data and the vehicle travel data of the same vehicle may be analyzed, such that the safety of the driving behavior of the driver for the same vehicle may be more accurately evaluated.

In the embodiment of the present disclosure, when the driver behavior data is alarm data, and/or the vehicle travel data is alarm data, at least one of the DMS or ADAS may send the alarm data to the cloud platform, and the cloud platform may verify and statistically analyze the alarm data when receiving the alarm data.

In some optional embodiments of the present disclosure, the driver data may further include a facial feature of the driver, and the method further includes: establishing a correspondence between the facial feature of the driver and the driver behavior data, a correspondence between the facial feature of the driver and the vehicle travel data, and a correspondence between the facial feature of the driver and the same vehicle identifier, respectively, in the database, in response to the first device identifier and the second device identifier corresponding to the same vehicle identifier.

In the embodiment of the present disclosure, the facial feature of the driver may be a feature extracted from the face image of the driver. Exemplarily, after acquiring the face image of the driver shot by the vehicle-mounted camera, the DMS may extract a facial feature of the driver from the face image of the driver by using a face recognition algorithm. In the embodiment of the disclosure, the type of the face recognition algorithm is not limited.

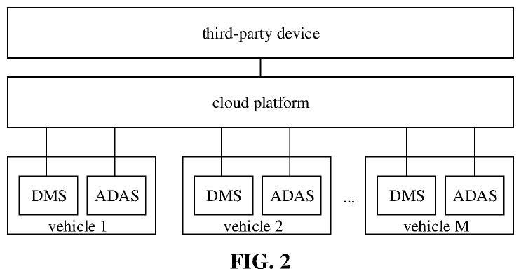

FIG. 2 is an architectural diagram of an application scenario according to an embodiment of the present disclosure. As shown in FIG. 2, a vehicle 1, a vehicle 2, . . . , and a vehicle M represent M different vehicles, M is an integer greater than or equal to 1, and each vehicle is provided with the DMS and the ADAS. The DMS of each vehicle may send the vehicle identifier, the first device identifier, the driver behavior data, and the facial feature of the driver as driver data to the cloud platform after extracting the facial feature of the driver. The ADAS of each vehicle may send the vehicle identifier, the second device identifier, and the vehicle travel data as vehicle data to the cloud platform. The cloud platform may establish an association between the driver behavior data and the vehicle travel data according to the first device identifier and the second device identifier corresponding to the same vehicle identifier, establish an association between the driver behavior data and the facial feature of the driver in the same driver data, and further establish a correspondence between the facial feature of the driver and the driver behavior data, a correspondence between the facial feature of the driver and the vehicle travel data, and a correspondence between the facial feature of the driver and the vehicle identifier, in the database.

It may be understood that since the facial feature of the driver represents a specific biometric feature of the actual driver of the vehicle, in the embodiment of the disclosure, by establishing a correspondence between the facial feature of the driver and the driver behavior data, a correspondence between the facial feature of the driver and the vehicle travel data, and a correspondence between the facial feature of the driver and the same vehicle identifier, the joint analysis of the driver behavior data and the vehicle travel data may be performed for the actual driver of the vehicle. Further, the driving behavior of the actual driver and the vehicle travel behavior of the vehicle may be considered comprehensively, such that the driving behavior of the actual driver of the vehicle may be analyzed more comprehensively, and the analysis result is more objective and accurate.

In some optional embodiments of the present disclosure, multiple facial features of the driver are stored in the database, and the method further includes: acquiring a driver data analysis request including a facial feature requested for analysis; determining a facial feature of the driver in the database matching the facial feature requested for analysis, and acquiring at least one of the driver behavior data or vehicle travel data corresponding to a determined facial feature of the driver; and performing the driver data analysis according to at least one of the determined driver behavior data or determined vehicle travel data.

In the present embodiment, the driver data analysis request may be acquired in the following manner. A vehicle-mounted device or a third-party device sends the driver data analysis request to a cloud platform, the third-party device may be an external device providing a third-party service, and the external device may form a communication connection with the cloud platform. The external device may be an electronic device such as a computer. The embodiments of the present disclosure do not limit the type of the third-party service, and exemplarily, the third-party service may be a business analysis service, a school bus service, or other third-party services.

In the embodiment of the present disclosure, when the vehicle-mounted device sends the driver data analysis request to the cloud platform, the facial feature requested for analysis is a feature extracted from the driver image shot by the vehicle-mounted camera. In this way, at least one of the driver behavior data or the vehicle travel data are acquired and analyzed according to the facial feature requested for analysis, and accurate behavior evaluation may be performed for the actual driver of the vehicle. That is, the driver evaluation result obtained through the analysis may reflect the driving behavior of the current driver of the vehicle.

In some optional embodiments of the present disclosure, performing driver data analysis according to at least one of the determined driver behavior data or determined vehicle travel data includes analyzing the safety of driving behavior of the driver according to at least one of the determined driver behavior data or determined vehicle travel data.

In the present embodiment, when the driver data analysis is performed on the basis of the determined driver behavior data and the vehicle travel data, the driving behavior and the vehicle travel behavior of the same driver may be comprehensively considered, such that the behavior of the same driver may be analyzed more comprehensively, and the analysis result is more objective and accurate.

The driver data analysis may be performed according to at least one of the determined driver behavior data or determined vehicle travel data in the following manner. Exemplarily, the safety of the driving behavior of the driver may be analyzed according to at least one of the determined driver behavior data or determined vehicle travel data. In this way, the safety of the driving behavior of each driver alone may be known.

Based on the foregoing description, the method for performing data analysis according to the facial feature of the driver according to the embodiment of the disclosure may be applied to multiple scenarios, and are described by way of example below.

The first scenario: a scenario in which one vehicle is used by one driver.

In this scenario, in the database, one vehicle identifier corresponds to the facial feature of one driver. The DMS of each vehicle may perform feature extraction on the image acquired by the vehicle-mounted camera to obtain the facial feature of the driver, and send driver data including the facial feature of the driver, the first device identifier, and the vehicle identifier to the cloud platform. In addition, the ADAS may send the vehicle data to the cloud platform separately, such that the facial feature of the driver corresponding to the vehicle identifier may be determined in the cloud platform, and then the driver behavior data and the vehicle travel data corresponding to the determined facial feature of the driver may be acquired according to the correspondence established in the database. Further, the driver data analysis may be performed.

The second scenario: a scenario in which one vehicle is shared by multiple drivers. For example, one vehicle may be assigned to different drivers in one motorcade for different periods of time.

In this scenario, in the database, one vehicle identifier corresponds to facial features of multiple drivers. For each driver of one vehicle driving the vehicle, the DMS in the vehicle may perform the feature extraction on the image acquired by the vehicle-mounted camera to obtain the facial feature of the driver, and may send driver data including the facial feature of the driver, the first device identifier, and the vehicle identifier to the cloud platform. The ADAS may further send vehicle data to the cloud platform separately. Thus, in the cloud platform, the facial feature of each driver corresponding to the vehicle identifier may be obtained according to the correspondence between the vehicle identifier and the facial feature of the driver. The driver behavior data and vehicle travel data corresponding to the facial feature of each driver may be obtained, and the driver data analysis may be performed for each driver corresponding to the vehicle. The implementation of the driver data analysis is described in the foregoing description, and details are not described herein.

The third scenario: a scenario in which one driver uses merely one vehicle.

In this scenario, in the database, the facial feature of one driver corresponds to one vehicle identifier. The DMS of each vehicle may perform the feature extraction on the image acquired by the vehicle-mounted camera to obtain the facial feature of the driver, and send driver data including the facial feature of the driver, the first device identifier, and the vehicle identifier to the cloud platform. Additionally, the ADAS may send vehicle data to the cloud platform separately. In this way, the vehicle identifier corresponding to the facial feature of the driver may be determined in the cloud platform, and the driver behavior data and the vehicle travel data corresponding to the determined vehicle identifier may be acquired according to the correspondence established in the database. Further, the driver data may be analyzed.

The fourth scenario: a scenario in which one driver uses multiple vehicles. For example, different vehicles in one motorcade may be assigned to one driver according to different periods of time.

In this scenario, in the database, the facial feature of one driver corresponds to multiple vehicle identifiers. When one driver drives multiple different vehicles at different times, the DMS in different vehicles may perform the feature extraction on the image acquired by the vehicle-mounted camera to obtain the facial feature of the driver, and may send driver data including the facial feature of the driver, the first device identifier, and the vehicle identifier to the cloud platform. The ADAS may further send the vehicle data to the cloud platform separately, such that in the cloud platform, the driver behavior data and the vehicle travel data corresponding to the facial feature of the same driver may be obtained according to the correspondence between the facial feature of the driver and the vehicle identifiers, and then the driver data analysis may be performed. The implementation of the driver data analysis is described in the foregoing description, and details are not described herein.

Optionally, the method further includes: receiving a vehicle data analysis request including a vehicle identifier requested for analysis; determining vehicle identifiers matching the vehicle identifiers requested for analysis in the database, and acquiring at least one of the driver behavior data or vehicle travel data corresponding to determined vehicle identifiers; and performing the vehicle data analysis according to at least one of the determined driver behavior data or determined vehicle travel data.

For the implementation of receiving the vehicle data analysis request, exemplarily, a vehicle-mounted device or a third-party device sends a driver data analysis request to a cloud platform.

It is to be understood that in the embodiment of the disclosure, the driver behavior data and the vehicle travel data corresponding to the vehicle identifier may be selected through the first mapping relationship established in the database, such that at least one of the driver behavior data or the vehicle travel data of the same vehicle may be analyzed. That is, the data may be analyzed separately for each vehicle, thereby facilitating learning the travel situation of each vehicle.

For the implementation of performing the vehicle data analysis according to at least one of the determined driver behavior data or determined vehicle travel data, exemplarily, the safety of the vehicle travel may be analyzed according to at least one of the determined driver behavior data or determined vehicle travel data. In this way, the travel situation of the vehicle for each vehicle alone may be known.

In some optional embodiments of the present disclosure, a second mapping relationship between the vehicle identifiers and the motorcade identifier is further pre-established in the database. The method further includes: determining at least two vehicle identifiers corresponding to a same motorcade identifier according to the second mapping relationship; and performing motorcade data analysis according to at least one of the driver behavior data or the vehicle travel data corresponding to each of the at least two vehicle identifiers. In the embodiment of the present disclosure, the motorcade identifier may be a motorcade name or other identifier information. The motorcade may include multiple vehicles.

In practical applications, the same vehicle-mounted device may upload the vehicle identifier and the identifier of the motorcade to which the vehicle belongs to the cloud platform, such that the cloud platform may establish the second mapping relationship between the vehicle identifier and the motorcade identifier in the database according to the vehicle identifier and the motorcade identifier sent by the same vehicle-mounted device.

It may be understood that, in the embodiment of the disclosure, by means of the second mapping relationship established in the database, it is possible to determine the identifiers of all vehicles in the same motorcade. Further, by means of the first mapping relationship established in the database, it is possible to select the driver behavior data and the vehicle travel data corresponding to all vehicle identifiers of the same motorcade, such that data analysis may be performed separately on each vehicle in each motorcade, thereby facilitating learning the travel situation of each vehicle in each motorcade and improving the efficiency of motorcade management.

For the implementation of performing the motorcade analysis data according to at least one of the driver behavior data or the vehicle travel data corresponding to each of the at least two vehicle identifiers, exemplarily, the safety of travel of the vehicle corresponding to each of the at least two vehicle identifiers may be analyzed according to at least one of the driver behavior data or the vehicle travel data corresponding to each of the at least two vehicle identifiers. In this way, the travel safety of all vehicles may be known for each motorcade alone.

In some optional embodiments of the present disclosure, a third mapping relationship between the facial feature of the driver and the motorcade identifier is further pre-established in the database. The method further includes: determining the facial feature of the at least two drivers corresponding to a same motorcade identifier according to the third mapping relationship; and performing the motorcade data analysis according to at least one of the driver behavior data or the vehicle travel data corresponding to the facial feature of each of the at least two drivers.

In practical applications, the same vehicle-mounted device may upload the facial features of the drivers and the identifier of the motorcade to which the vehicle belongs to the cloud platform, such that the cloud platform may establish the third mapping relationship between the facial features of the drivers and the motorcade identifier in the database according to the facial features of the drivers and the motorcade identifier sent by the same vehicle-mounted device.

It may be understood that, in the embodiment of the disclosure, by means of the third mapping relationship established in the database, it is possible to determine the facial features of all drivers of the same motorcade. Further, the driver behavior data and the vehicle travel data corresponding to all drivers of the same motorcade may be selected according to the face features of all drivers of the same motorcade in combination with the pre-established correspondence between the facial features of the drivers and the driver behavior data and the pre-established correspondence between the facial features of the drivers and the vehicle travel data. Further, the data analysis may be performed separately for each driver of each motorcade, thereby facilitating learning the driver behavior of each motorcade and improving the efficiency of motorcade management.

For the implementation of performing the motorcade data analysis according to at least one of the driver behavior data or the vehicle travel data corresponding to the facial feature of each of the at least two drivers, exemplarily, the safety of driving behavior of the driver corresponding to the facial feature of each of the at least two drivers is analyzed according to at least one of the driver behavior data or the vehicle travel data corresponding to the facial feature of each of the at least two drivers. In this way, the safety of the driving behavior of all the drivers may be known for each motorcade alone.

In some optional embodiments of the present disclosure, the analysis result may be derived from at least one of driver data analysis or vehicle data analysis. Optionally, referring to FIG. 2, after the analysis result is obtained, the analysis result may be sent to the third-party device. In practical applications, the third-party device may send a subscription request to the cloud platform for requesting to acquire the analysis result. After receiving the subscription request, the cloud platform may send the analysis result to the third-party device according to the subscription request. After receiving the analysis result, the third-party device may perform secondary analysis on the analysis result to obtain a secondary analysis result. The third-party device may determine how to analyze the analysis result according to the third-party service provided by the third-party device.

As an implementation, the third party device may perform the secondary analysis based on the analysis result and the third party data. The third-party data may represent non-driving behavior data of the driver. For example, the third-party data may be shopping data, web page browsing data, or the like, of the driver. In a specific implementation, the cloud platform may send the facial feature of the driver and the analysis result to the third-party device, and the third-party device may acquire the third-party data of the driver based on the received facial feature of the corresponding driver.

It is to be understood that, the interaction with the third-party device facilitates the third-party device to perform the secondary analysis using the analysis result, thereby extending the application scenarios of the embodiments of the present disclosure.

In some optional embodiments of the present disclosure, the analysis result may be sent to the vehicle-mounted device after the analysis result is derived. Or, the recommendation information may be obtained from the analysis result, and the recommendation information may be sent to the vehicle-mounted device. Further, the vehicle-mounted device may present the analysis result or recommendation information.

The recommendation information may be information that meets a preset requirement. For example, the recommendation information may be driving warning information or other types of information.

It may be seen that, through sending the analysis result or recommendation information to the vehicle-mounted device, the vehicle-mounted device may acquire the corresponding information, and further, the vehicle-mounted device may interact with the driver, thereby facilitating the driver to acquire the corresponding information and improving the interactivity.

It is to be understood by those skilled in the art that, in the abovementioned methods of the embodiments, the order in which the steps are described does not imply a strict order of execution to constitute any limitation on the implementation, and the specific order of execution of the steps should be determined in terms of their functions and possible intrinsic logic.

On the basis of the method for data analysis set forth in the foregoing embodiment, an embodiment of the disclosure provides an apparatus for data analysis.

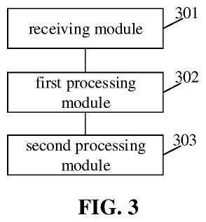

FIG. 3 is a structural diagram of an apparatus for data analysis according to an embodiment of the present disclosure. As shown in FIG. 3, the apparatus includes a receiving module 301, a first processing module 302, and a second processing module 303. The receiving module 301 is configured to receive driver data sent by the DMS and vehicle data sent by the ADAS. The driver data includes driver behavior data and a first device identifier of the DMS, the vehicle data includes vehicle travel data and a second device identifier of ADAS, and the DMS and ADAS are provided in the vehicle.

The first processing module 302 is configured to determine a vehicle identifier corresponding to the first device identifier and a vehicle identifier corresponding to the second device identifier according to a first mapping relationship between device identifiers and vehicle identifiers established in a database.

The second processing module 303 is configured to perform at least one of driver data analysis or vehicle data analysis according to the driver behavior data and the vehicle travel data in response to the first device identifier and the second device identifier corresponding to a same vehicle identifier.

In some optional embodiments of the present disclosure, the driver data further includes a facial feature of the driver, and the first processing module 302 is further configured to establish a correspondence between the facial feature of the driver and the driver behavior data, a correspondence between the facial feature of the driver and the vehicle travel data, and a correspondence between the facial feature of the driver and the same vehicle identifier, respectively, in the database, in response to the first device identifier and the second device identifier corresponding to the same vehicle identifier.

In some optional embodiments of the present disclosure, facial features of a plurality of drivers are stored in the database, and the second processing module 303 is further configured to acquire a driver data analysis request including a facial feature requested for analysis; determine a facial feature of the driver in the database matching the facial feature requested for analysis, and acquire at least one of the driver behavior data or vehicle travel data corresponding to a determined facial feature of the driver; and perform the driver data analysis according to at least one of the determined driver behavior data or determined vehicle travel data.

In some optional embodiments of the present disclosure, the second processing module 303 is configured to analyze safety of driving behavior of the driver according to at least one of the determined driver behavior data or determined vehicle travel data.

In some optional embodiments of the present disclosure, the facial feature of the driver is a feature extracted from a face image of the driver.

In some optional embodiments of the present disclosure, the facial feature of one driver corresponds to one or more vehicle identifiers.

In some optional embodiments of the present disclosure, one vehicle identifier corresponds to facial features of one or more drivers.

In some optional embodiments of the present disclosure, the second processing module 303 is further configured to receive a vehicle data analysis request including a vehicle identifier requested for analysis; determine a vehicle identifier matching the vehicle identifier requested for analysis in the database, and acquire at least one of the driver behavior data or vehicle travel data corresponding to a determined vehicle identifier; and perform the vehicle data analysis according to at least one of the determined driver behavior data or determined vehicle travel data.

In some optional embodiments of the present disclosure, the second processing module 303 is configured to analyze safety of the vehicle travel according to at least one of the determined driver behavior data or determined vehicle travel data.

In some optional embodiments of the present disclosure, a second mapping relationship between vehicle identifiers and motorcade identifiers is further pre-established in the database. The second processing module 303 is further configured to determine at least two vehicle identifiers corresponding to a same motorcade identifier according to the second mapping relationship; and perform motorcade data analysis according to at least one of the driver behavior data or the vehicle travel data corresponding to each of the at least two vehicle identifiers.

In some optional embodiments of the present disclosure, the second processing module 303 is configured to analyze safety of vehicle travel corresponding to each of the at least two vehicle identifiers according to at least one of the driver behavior data or the vehicle travel data corresponding to each of the at least two vehicle identifiers.

In some optional embodiments of the present disclosure, a third mapping relationship between facial features of drivers and motorcade identifiers is further pre-established in the database. The second processing module 303 is further configured to determine the facial features of the at least two drivers corresponding to a same motorcade identifier according to the third mapping relationship; and perform the motorcade data analysis according to at least one of the driver behavior data or the vehicle travel data corresponding to the facial feature of each of the at least two drivers.

In some optional embodiments of the present disclosure, the second processing module 303 is configured to analyze the safety of driving behavior of the driver corresponding to the facial feature of each of the at least two drivers according to at least one of the driver behavior data or the vehicle travel data corresponding to the facial feature of each of the at least two drivers.

In some optional embodiments of the present disclosure, the driver behavior data includes at least one of yawning, calling, drinking water, smoking, making up, or the driver not being in a driving position; and the vehicle travel data includes at least one of a lane departure warning, a forward collision warning, an overspeed warning, a pedestrian in front of the vehicle, a backward collision warning, or an obstacle in front of the vehicle.

In some optional embodiments of the present disclosure, the second processing module 303 is further configured to send result information including an analysis result obtained through at least one of driver data analysis or vehicle data analysis to a third-party device.

In some optional embodiments of the present disclosure, the second processing module 303 is further configured to send an analysis result obtained through at least one of driver data analysis or vehicle data analysis to a vehicle-mounted device of the vehicle; or obtain recommendation information based on the analysis result, and send the recommendation information to the vehicle-mounted device.

In practical applications, each of the receiving module 301, the first processing module 302, and the second processing module 303 may be implemented by a processor in a cloud platform. The processor may be at least one of an ASIC, a DSP, a DSPD, a PLD, an FPGA, a CPU, a controller, a microcontroller, or a microprocessor.

In addition, the functional modules in the present embodiments may be integrated in one processing unit, or each unit may exist alone physically, or two or more units may be integrated in one unit. The integrated units described above may be implemented in the form of hardware or in the form of software functional modules.

The integrated unit, when not sold or used as a stand-alone product in the form of a software functional module, may be stored in a computer-readable storage medium. It is understood that the technical solution of the present embodiments may be embodied in the form of a software product in which instructions are included to cause a computer device (which may be a personal computer, a server, a network device, or the like) or processor to perform all or part of the steps of the methods described in the present embodiments. The storage medium includes a USB flash drive, a removable hard disk, a Read Only Memory (ROM), a Random Access Memory (RAM), a magnetic disk, or an optical disk.

Specifically, computer program instructions corresponding to a method for data analysis in the present embodiments may be stored in a storage medium such as an optical disk, a hard disk, or a USB flash disk. When the computer program instructions corresponding to the method for data analysis in the storage medium is read or executed by an electronic device, any one of the methods for data analysis in the foregoing embodiments is implemented.

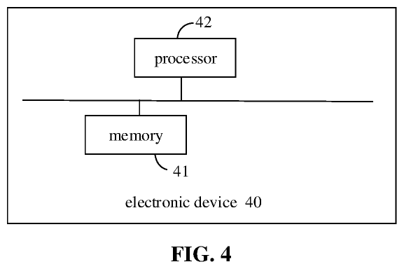

Based on the same technical concept of the foregoing embodiments, referring to FIG. 4, an electronic device 40 provided in an embodiment of the present disclosure may include a memory 41 and a processor 42.

The memory 41 is configured to store computer programs and data.

The processor 42 is configured to execute computer programs stored in the memory to implement any of the methods for data analysis of the foregoing embodiments.

In practical applications, the memory 41 may be a volatile memory such as a RAM; or non-volatile memory such as ROM, flash memory, Hard Disk Drive (HDD) or Solid-State Drive (SSD); or a combination of memories of the kinds described above. The memory 41 provides instructions and data to the processor 42.

The processor 42 may be at least one of an ASIC, a DSP, a DSPD, a PLD, an FPGA, a CPU, a controller, a microcontroller, or a microprocessor. It is to be understood that for different devices, the electronic elements for implementing the above-described processor functions may be other elements, which are not specifically limited in the embodiments of the present disclosure.

In some embodiments, the device provided in the embodiments of the present disclosure may have functions or include modules for performing the methods described in the above method embodiments, and for the specific implementations thereof, reference may be made to the above method embodiments, of which the details are not described herein for brevity.

The embodiment of the disclosure further provides a computer storage medium having stored thereon computer programs which, when executed by a processor, implements any one of the methods for driving data analysis described above in the embodiments of the disclosure.

The embodiment of the present disclosure further provides a computer program product. The computer program product includes computer program instructions which, when executed, cause a computer to implement any of the methods for driving data analysis described above in the embodiments of the present disclosure.

According to the method and apparatus for data analysis, the electronic device, and the computer storage medium provided in the embodiments of the disclosure, driver data sent by a DMS and vehicle data sent by an ADAS is received, the driver data includes driver behavior data and a first device identifier of the DMS, the vehicle data includes vehicle travel data and a second device identifier of ADAS, and the DMS and ADAS are provided in a vehicle. A vehicle identifier corresponding to the first device identifier and a vehicle identifier corresponding to the second device identifier are determined according to a first mapping relationship between device identifiers and vehicle identifiers established in a database. In response to the first device identifier and the second device identifier corresponding to a same vehicle identifier, at least one of driver data analysis or vehicle data analysis is performed according to the driver behavior data and the vehicle travel data. In this way, in the embodiments of the disclosure, the vehicle identifier is used as a medium to correlate the driver behavior data and the vehicle travel data of the same vehicle, and further to perform joint data analysis on the driver behavior data and the vehicle travel data of the same vehicle, such that the comprehensiveness, accuracy, and flexibility of the data analysis may be improved, and effective driver management, vehicle management, and/or motorcade management may be achieved.

The foregoing description of various embodiments is intended to emphasize differences between the various embodiments, and for the same or similar parts, references may be made to each other, of which the details are not described herein for the sake of brevity.

The methods disclosed in various method embodiments provided herein may be combined arbitrarily without conflict to obtain new method embodiments.

The features disclosed in various product embodiments provided herein may be combined arbitrarily without conflict to obtain new product embodiments.

The features disclosed in each method or device embodiment provided in the present application may be combined arbitrarily without conflict to obtain a new method embodiment or device embodiment.

From the above description of the embodiments, it is apparent to those skilled in the art that the methods of the above embodiments may be implemented by means of software plus a necessary general hardware platform, or may be implemented by means of hardware, and in many cases the former is the preferred embodiment. Based on such an understanding, the essence or the part that contributes to the prior art of the technical solution of the present invention may be embodied in the form of a software product. The software product is stored in a storage medium (such as a ROM/RAM, a magnetic disk, or an optical disk) including instructions for causing a terminal (which may be a mobile phone, a computer, a server, an air conditioner, or a network device) to perform the methods described in various embodiments of the present invention.

The embodiments of the present disclosure have been described above in connection with the accompanying drawings, but the present disclosure is not limited to the foregoing detailed description, which is merely illustrative and not restrictive. Many modifications may be made by those of ordinary skill in the art without departing from the spirit of the disclosure and the scope of the claims, all of which are within the protection of the disclosure.

1. A method for data analysis, comprising:
receiving driver data sent by a driver monitor system (DMS) and vehicle data sent by an advanced driving assistant system (ADAS), wherein the driver data comprises driver behavior data and a first device identifier of the DMS, the vehicle data comprises vehicle travel data and a second device identifier of ADAS, and the DMS and ADAS are provided in a vehicle;
determining a vehicle identifier corresponding to the first device identifier and a vehicle identifier corresponding to the second device identifier according to a first mapping relationship between the device identifier and the vehicle identifier established in a database; and
in response to the first device identifier and the second device identifier corresponding to a same vehicle identifier, performing at least one of driver data analysis or vehicle data analysis according to the driver behavior data and the vehicle travel data.

2. The method of claim 1, wherein the driver data further comprises a facial feature of a driver, and the method further comprises:
in response to the first device identifier and the second device identifier corresponding to the same vehicle identifier, establishing a correspondence between the facial feature of the driver and the driver behavior data, a correspondence between the facial feature of the driver and the vehicle travel data, and a correspondence between the facial feature of the driver and the same vehicle identifier, in the database.

3. The method of claim 2, wherein facial features of a plurality of drivers are stored in the database, and the method further comprises:
acquiring a driver data analysis request including a facial feature requested for analysis;
determining a facial feature of the driver in the database matching the facial feature requested for analysis, and acquiring at least one of the driver behavior data or vehicle travel data corresponding to a determined facial feature of the driver; and
performing the driver data analysis according to at least one of the driver behavior data or vehicle travel data.

4. The method of claim 3, wherein performing driver data analysis according to at least one of the driver behavior data or vehicle travel data comprises:
analyzing safety of a driving behavior of the driver according to at least one of the driver behavior data or vehicle travel data.

5. The method of claim 2, wherein the facial feature of the driver is a feature extracted from a face image of the driver.

6. The method of claim 2, wherein in the database, the facial feature of one driver corresponds to one or more vehicle identifiers.

7. The method of claim 2, wherein in the database, one vehicle identifier corresponds to facial features of one or more drivers.

8. The method of claim 1, wherein the method further comprises:
receiving a vehicle data analysis request comprising a vehicle identifier requested for analysis;
determining a vehicle identifier matching the vehicle identifier requested for analysis in the database, and acquiring at least one of the driver behavior data or vehicle travel data corresponding to the determined vehicle identifier; and
performing the vehicle data analysis according to at least one of the driver behavior data or vehicle travel data.

9. The method of claim 8, wherein performing the vehicle data analysis according to at least one of the driver behavior data or vehicle travel data comprises:
analyzing safety of vehicle travel according to at least one of the driver behavior data or vehicle travel data.

10. The method of claim 1, wherein a second mapping relationship between vehicle identifiers and a motorcade identifier is further pre-established in the database, and the method further comprises:
determining at least two vehicle identifiers corresponding to a same motorcade identifier according to the second mapping relationship; and
performing motorcade data analysis according to at least one of the driver behavior data or the vehicle travel data corresponding to each of the at least two vehicle identifiers.

11. The method of claim 10, wherein performing the motorcade data analysis according to at least one of the driver behavior data or the vehicle travel data corresponding to each of the at least two vehicle identifiers comprises:
analyzing safety of vehicle travel corresponding to each of the at least two vehicle identifiers according to at least one of the driver behavior data or the vehicle travel data corresponding to each of the at least two vehicle identifiers.

12. The method of claim 10, wherein a third mapping relationship between facial features of drivers and a motorcade identifier is further pre-established in the database, and the method further comprises:
determining facial features of at least two drivers corresponding to a same motorcade identifier according to the third mapping relationship; and
performing the motorcade data analysis according to at least one of the driver behavior data or the vehicle travel data corresponding to the facial feature of each of the at least two drivers.

13. The method of claim 12, wherein performing the motorcade data analysis according to at least one of the driver behavior data or the vehicle travel data corresponding to the facial feature of each of the at least two drivers comprises:
analyzing safety of a driving behavior corresponding to the facial feature of each of the at least two drivers according to at least one of the driver behavior data or the vehicle travel data corresponding to the facial feature of each of the at least two drivers.

14. The method of claim 1, wherein the driver behavior data comprises at least one of yawning, calling, drinking water, smoking, making up, or a driver not being in a driving position; and the vehicle travel data comprises at least one of a lane departure warning, a forward collision warning, an overspeed warning, a pedestrian in front of the vehicle, a backward collision warning, or an obstacle in front of the vehicle.

15. The method of claim 1, wherein the method further comprises:
sending result information comprising an analysis result obtained through at least one of driver data analysis or vehicle data analysis to a third-party device.

16. The method of claim 1, wherein the method further comprises:
sending an analysis result obtained through at least one of driver data analysis or vehicle data analysis to a vehicle-mounted device of the vehicle; or
obtaining recommendation information according to the analysis result, and sending the recommendation information to the vehicle-mounted device.

17. An electronic device comprising a processor and a memory configured to store a computer program executable by the processor; wherein
the processor is configured to execute the computer program to:
receive driver data sent by a driver monitor system (DMS) and vehicle data sent by an advanced driving assistant system (ADAS), wherein the driver data comprises driver behavior data and a first device identifier of the DMS, the vehicle data comprises vehicle travel data and a second device identifier of ADAS, and the DMS and ADAS are provided in a vehicle;
determine a vehicle identifier corresponding to the first device identifier and a vehicle identifier corresponding to the second device identifier according to a first mapping relationship between the device identifier and the vehicle identifier established in a database; and
in response to the first device identifier and the second device identifier corresponding to a same vehicle identifier, perform at least one of driver data analysis or vehicle data analysis according to the driver behavior data and the vehicle travel data.

18. The electronic device of claim 17, wherein the driver data further comprises a facial feature of a driver, and the processor is further configured to:
in response to the first device identifier and the second device identifier corresponding to the same vehicle identifier, establish a correspondence between the facial feature of the driver and the driver behavior data, a correspondence between the facial feature of the driver and the vehicle travel data, and a correspondence between the facial feature of the driver and the same vehicle identifier, in the database.

19. The electronic device of claim 18, wherein facial features of a plurality of drivers are stored in the database, and the processor is further configured to:
acquire a driver data analysis request including a facial feature requested for analysis;
determine a facial feature of the driver in the database matching the facial feature requested for analysis, and acquiring at least one of the driver behavior data or vehicle travel data corresponding to a determined facial feature of the driver; and
perform the driver data analysis according to at least one of the driver behavior data or determined vehicle travel data.

20. A non-transitory computer storage medium having stored thereon a computer program which, when executed by a processor, causes the processor to:
receive driver data sent by a driver monitor system (DMS) and vehicle data sent by an advanced driving assistant system (ADAS), wherein the driver data comprises driver behavior data and a first device identifier of the DMS, the vehicle data comprises vehicle travel data and a second device identifier of ADAS, and the DMS and ADAS are provided in a vehicle;
determine a vehicle identifier corresponding to the first device identifier and a vehicle identifier corresponding to the second device identifier according to a first mapping relationship between the device identifier and the vehicle identifier established in a database; and
in response to the first device identifier and the second device identifier corresponding to a same vehicle identifier, perform at least one of driver data analysis or vehicle data analysis according to the driver behavior data and the vehicle travel data.
